(19) United States
(12) Patent Application Publication
(10) Pub. No.: US 2017/0351528 A1
(43) Pub. Date: Dec. 7, 2017

(54) METHOD AND APPARATUS TO DEPLOY INFORMATION TECHNOLOGY SYSTEMS

(71) Applicant: HITACHI, LTD., Tokyo (JP)

(72) Inventor: Yasutaka KONO, Tokyo (JP)

(73) Assignee: HITACHI, LTD., Tokyo (JP)

(21) Appl. No.: 15/537,445

(22) PCT Filed: May 7, 2015
(86) PCT No.: PCT/US15/29605

§ 371 Date: Jun. 19, 2017

(51) Int. Cl. G06F 9/44; G06F 9/455; G06F 13/20

(52) U.S. Cl. CPC G06F 9/4401; G06F 13/20; G06F 9/45558; G06F 2009/45579

(57) ABSTRACT

Exemplary embodiments provide method and apparatus for deploying new systems agilely without preventing stable operation of existing IT systems. In one embodiment, a management computer is coupled to a first system. The management computer includes a memory and a processor. The processor is configured, in receipt of a request to deploy a second system which will issue an access to the first system, to create a constraint which limits the access to the first system issued by the second system, and deploy the second system, to which the created constraint is set, to operate the second system with the created constraint.

### BACKGROUND OF THE INVENTION

The present invention relates generally to IT (Information Technology) and, more particularly, to deployment of IT systems stably and agilely.

There are growing needs for deploying new IT systems (applications and IT resources) agilely to adapt to rapid changes on businesses. It is important to shorten the time required to start new systems. At the same time, existing system must be run stably to avoid loss of business opportunities. Such systems must be carefully designed, implemented, and validated. Current technologies are available to automate provisioning of IT resources and deploying applications to enable agile deployment of new systems. These technologies suffer from certain problems.

There is a trade-off when deploying a new system related to existing system(s) agilely. If the new system is deployed after validating impacts to the existing system(s), it takes a long time. If the new system is deployed without validating impacts to the existing system(s), there are risks that it will cause unexpected problems for the existing system(s).

U.S. Patent Application Publication No. 2013/0232498 discloses a system to generate a deployment plan for a cloud infrastructure according to logical, multi-tier application blueprint. A deployment system enables a developer to generate a deployment plan according to a logical, multi-tier application blueprint defined by application architects. The deployment plan includes tasks to be executed for deploying application components on virtual computing resource provided in a cloud infrastructure. The deployment plan includes time dependencies that determine an execution order of the tasks according to dependencies between application components specified in the application blueprint. The deployment plan enables system administrators to view the application blueprint as an ordered workflow view that facilitates collaboration between system administrators and application architects.

### BRIEF SUMMARY OF THE INVENTION

Exemplary embodiments of the invention provide method and apparatus for deploying new systems agilely without preventing stable operation of existing IT systems. When a management program deploys new system(s), it judges whether impact validation to existing system(s) is necessary and whether impact validation can be done immediately. If impact validation is necessary but cannot be done immediately, the management program creates constraint(s) and deploys the new system(s) after setting the created constraint(s). The management program monitors performance and failure of the newly deployed system(s). If a sufficient amount of data is retrieved, the management program estimates impacts to the existing system(s) with the assumption that the constraints are not applied. If the estimated impacts are acceptable for the existing system(s), the management program removes or eases the constraint(s) applied to the newly deployed system(s), which is/are deemed unnecessary or unnecessarily harsh. The management program also monitors changes on the newly deployed system(s). If there are changes on the newly deployed system(s), the management program creates constraint(s) again and re-applies the constraint(s) to the newly deployed system(s), since there might be other impacts not validated yet. As a result, new systems can be deployed agilely without preventing stable operation of existing IT system. Unnecessary constrains can be removed or eased after impact validation is done. It is possible to re-apply constraints when newly deployed systems are changed and there might be other impacts not validated yet. These features are not disclosed in US2013/0232498 discussed above.

An aspect of the present invention is directed to a management computer coupled to a first system. The management computer comprises a memory and a processor. The processor is configured, in receipt of a request to deploy a second system which will issue an access to the first system, to create a constraint which limits the access to the first system issued by the second system, and deploy the second system, to which the created constraint is set, to operate the second system with the created constraint.

In some embodiments, the processor is configured to: retrieve an impact validation level associated to the first system as a result of deploying the second system; determine whether impact validation is necessary for the first system based on the retrieved impact validation level; and if the impact validation is determined to be necessary and if the impact validation cannot be performed immediately, then create the constraint and deploy the second system to operate the second system with the created constraint.

In specific embodiments, the processor is configured, upon determining that impact validation is necessary, to determine whether performance impact validation is necessary based on the impact validation level and, if yes, then analyze spare performance of the first system; and create the constraint of resource usage of the second system being deployed based on the spare performance of the first system. The constraint of resource usage of the second system includes one or more of capping I/O (Input/Output) from the second system to the first system, limiting network bandwidth, setting a low priority to network packets transfer between the first and second systems, limiting CPU (Central Processing Unit) usage of the second system, or limiting memory usage of the second system.

In some embodiments, the processor is configured, upon determining that impact validation is necessary, to determine whether failure impact validation is necessary based on the impact validation level and, if yes, then create the constraint of access pattern from the second system being deployed to the first system. The constraint of access pattern includes one or more of limiting I/O access to read-only from the second system to the first system, allocating different I/O paths between the first system and the second system from I/O paths used by the first system, or limiting candidates of physical servers on which to deploy the second system.

In specific embodiments, the processor is configured to provide a graphical user interface to an administrator to associate impact validation levels to one or more systems including the first system as a result of deploying the second system. Each impact validation level indicates whether performance impact validation is necessary or not and, if necessary, specifies a period of time of running data for the performance impact validation. Each impact validation level indicates whether failure impact validation is necessary or not.

In some embodiments, the processor is configured to monitor performance and failure of the deployed second system and, upon collecting sufficient data from the monitoring, then estimate impact on the first system by deploying the second system assuming that the created constraint is not applied; and show the estimated impact to an administrator. The processor is configured, upon receiving instruction from the administrator that the estimated impact is acceptable, to remove or ease the created constraint applied to the deployed second system. The processor is configured to monitor change of the deployed second system and, upon detecting change of the deployed second system which has potential impact on the first system, to create another constraint which limits the access to the first system issued by the second system; and apply the created another constraint to the deployed second system to operate the second system with the created another constraint.

Another aspect of the invention is directed to a method of managing access to a first system which includes a first processor and a first memory. The method comprises, in receipt of a request to deploy a second system which will issue an access to the first system, creating a constraint which limits the access to the first system issued by the second system, and deploying the second system, to which the created constraint is set, to operate the second system with the created constraint.

Another aspect of this invention is directed to a non-transitory computer-readable storage medium storing a plurality of instructions for controlling a data processor to manage access to a first system which includes a first processor and a first memory. The plurality of instructions comprise instructions that cause the data processor to create a constraint which limits the access to the first system issued by the second system, and instructions that cause the data processor to deploy the second system, to which the created constraint is set, to operate the second system with the created constraint.

These and other features and advantages of the present invention will become apparent to those of ordinary skill in the art in view of the following detailed description of the specific embodiments.

### BRIEF DESCRIPTION OF THE DRAWINGS

FIG. 1 illustrates an example of a logical configuration of the system in which the method and apparatus of the invention may be applied.

FIG. 1-A shows a logical configuration of the IT infrastructure of FIG. 1.

FIG. 1-B shows a physical configuration of the IT environment of the first embodiment.

FIG. 2 shows a configuration of the management server of FIG. 1-B.

FIG. 3 shows an example of the image catalog table.

FIG. 4 shows an example of the VM template table.

FIG. 5 shows an example of the storage array table.

FIG. 6 shows an example of the storage volume table.

FIG. 7 shows an example of the physical server table.

FIG. 8 shows an example of the virtual server table.

FIG. 9 shows an example of the mapping table.

FIG. 10 shows an example of the storage performance table.

FIG. 11 shows an example of the server performance table.

FIG. 12 shows an example of the impact validation level table.

FIG. 13 shows an example of the impact validation level association table.

FIG. 14 shows an example of a GUI (Graphical User Interface) of the self-service portal for associating an impact validation level to a system.

FIG. 15 shows an example of a GUI of the self-service portal for deploying applications.

FIG. 16 shows an example of a confirmation GUI of the self-service portal.

FIG. 17 shows an example of a system relation input GUI of the self-service portal.

FIG. 18 shows an example of a flow diagram illustrating a process of the management program for deploying systems.

FIG. 19 shows an example of a flow diagram illustrating a process of the management program for creating constraints sub-sequence.

FIG. 20 shows an example of space performance of an existing system potentially being affected.

FIG. 21 shows an example of a flow diagram illustrating a process of the management program for easing of constraints sequence.

FIG. 22 shows an example of a flow diagram illustrating a process of the management program for re-applying constraints to the newly deployed systems.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment,” “this embodiment,” or “these embodiments” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

Furthermore, some portions of the detailed description that follow are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the present invention, the steps carried out require physical manipulations of tangible quantities for achieving a tangible result. Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

The present invention also relates to an apparatus for performing the operations herein. This apparatus may be specially constructed for the required purposes, or it may include one or more general-purpose computers selectively activated or reconfigured by one or more computer programs. Such computer programs may be stored in a computer-readable storage medium including non-transitory medium, such as, but not limited to optical disks, magnetic disks, read-only memories, random access memories, solid state devices and drives, or any other types of media suitable for storing electronic information. The algorithms and displays presented herein are not inherently related to any particular computer or other apparatus. Various general-purpose systems may be used with programs and modules in accordance with the teachings herein, or it may prove convenient to construct a more specialized apparatus to perform desired method steps. In addition, the present invention is not described with reference to any particular programming language. It will be appreciated that a variety of programming languages may be used to implement the teachings of the invention as described herein. The instructions of the programming language(s) may be executed by one or more processing devices, e.g., central processing units (CPUs), processors, or controllers.

Exemplary embodiments of the invention, as will be described in greater detail below, provide apparatuses, methods and computer programs for deployment of IT systems stably and agilely.

### First Embodiment

The first embodiment discloses how the management program agilely deploys a new IT system with constraints not to prevent stable operation of existing IT system.

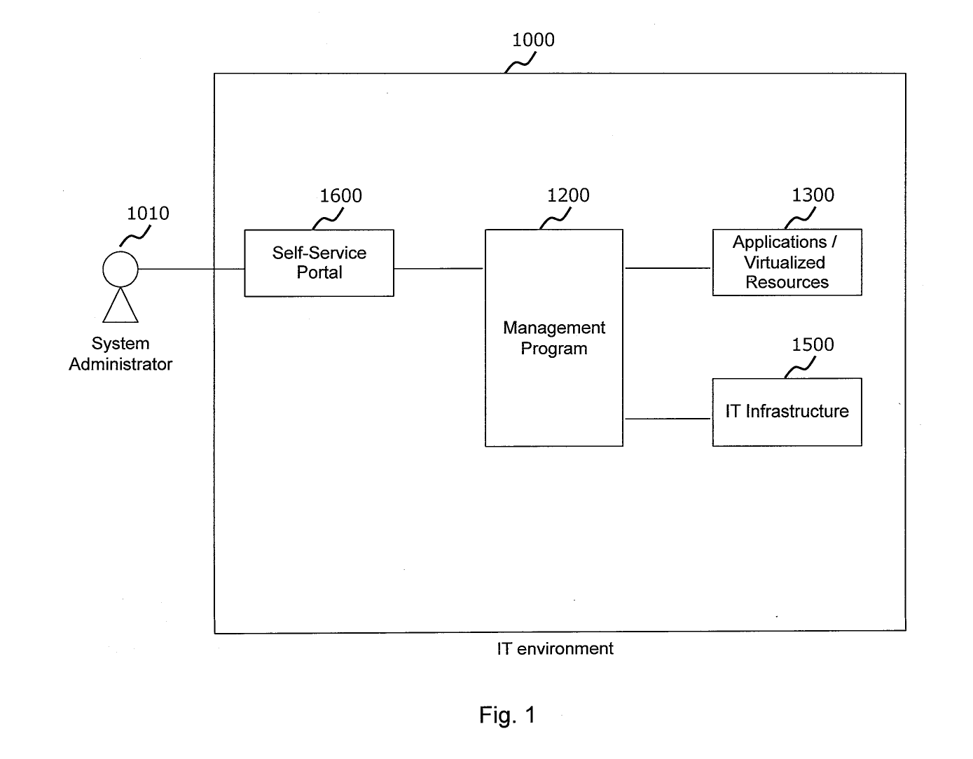

FIG. 1 illustrates an example of a logical configuration of the system in which the method and apparatus of the invention may be applied. An IT environment 1000 includes management program 1200, applications and virtualized resources 1300, IT infrastructure 1500, and self-service portal 1600. The system administrator 1010 uses this IT environment via a self-service portal 1600.

FIG. 1-A shows a logical configuration of the IT infrastructure of FIG. 1. The IT infrastructure 1500 includes one or more systems. There are IT System 01 and 02 (1560 and 1570) in FIG. 1-A. Application 1544, OS 1543 and VM 1542 are running on Hypervisor 1541. This hypervisor is running on Server 1540. Application 1556, 1557, OS 1554 and 1555, and VM 1552 and 1553 are running on Hypervisor 1551. This hypervisor is running on Server 1550. Application 1544 uses Storage volume 1511 and 1512 of Storage system 01 (1510). Application 1556 uses Storage volume 1521 of Storage system 02 (1520). Application 1557 uses Storage volume 1522 of Storage system 02 (1520).

FIG. 1-B shows a physical configuration of the IT environment of the first embodiment. The IT environment 1000 includes management server 2000, servers 3000, storage arrays 4000, management network 5000, and data network 6000. Servers 3000 and storage arrays 4000 are connected via data network 6000. This network can be LAN (Local Area Network) but it is not limited to that. Management server 2000, servers 3000, and storage arrays 4000 are connected via management network 5000. This Network is usually LAN, but it is not limited to that. Although management network and data network are separate in the figure, they can be a single converged network. In FIG. 1-B, management server 2000 and servers 3000 are separate, but the invention is not limited to this. For example, any server can host a management program. In FIG. 1-B, servers 3000 and storage arrays 4000 are separate, but the invention is not limited to this. For example, servers and storages arrays can be converged into one system. The IT environment 1000 may be referred to as a cloud system.

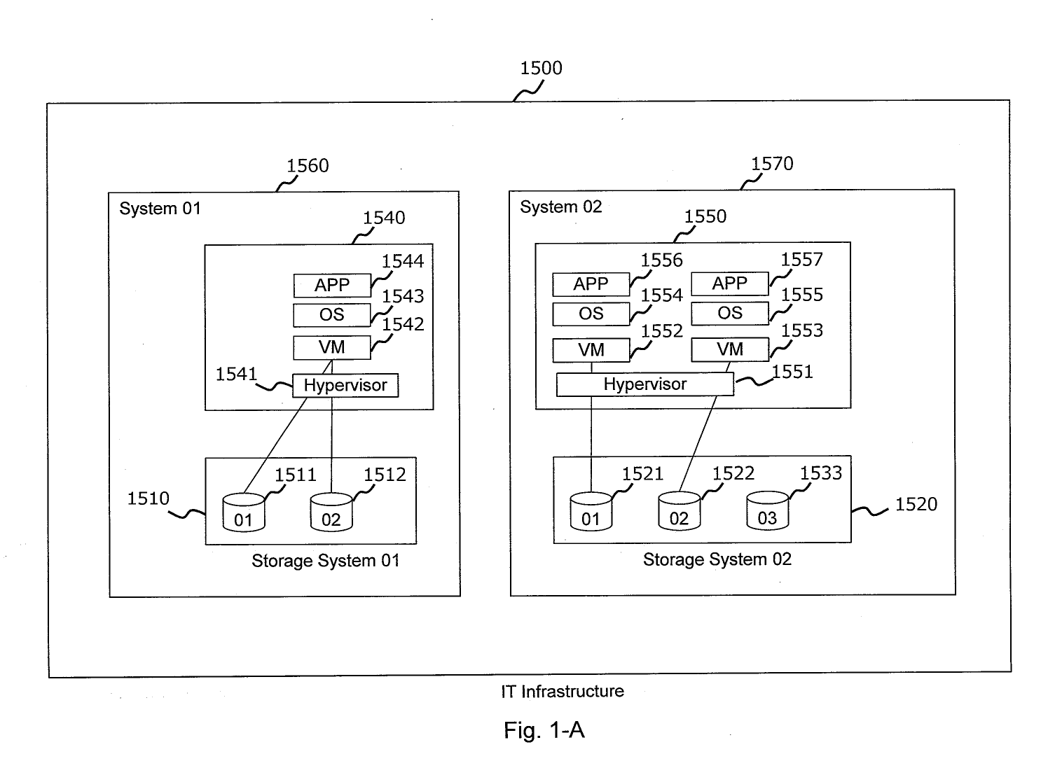

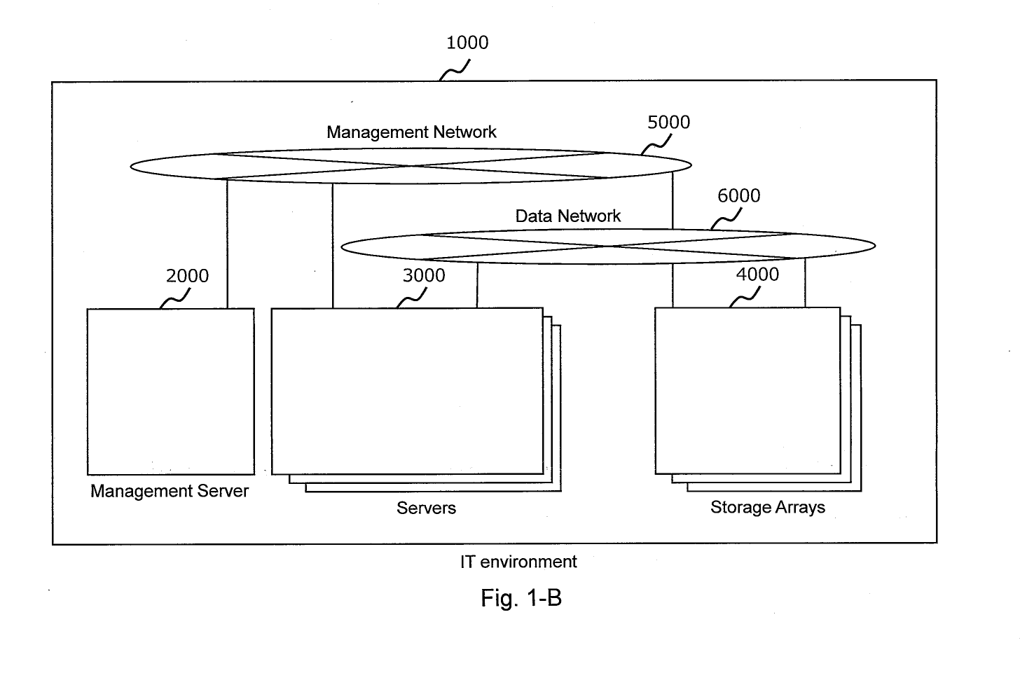

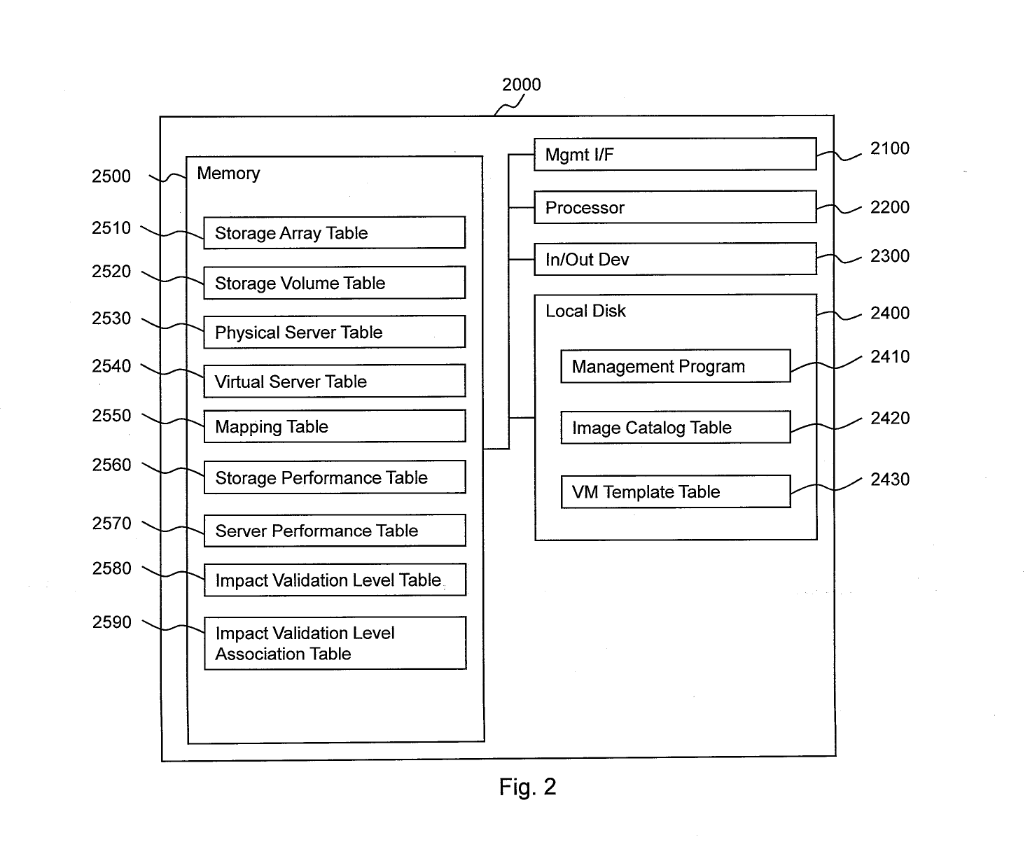

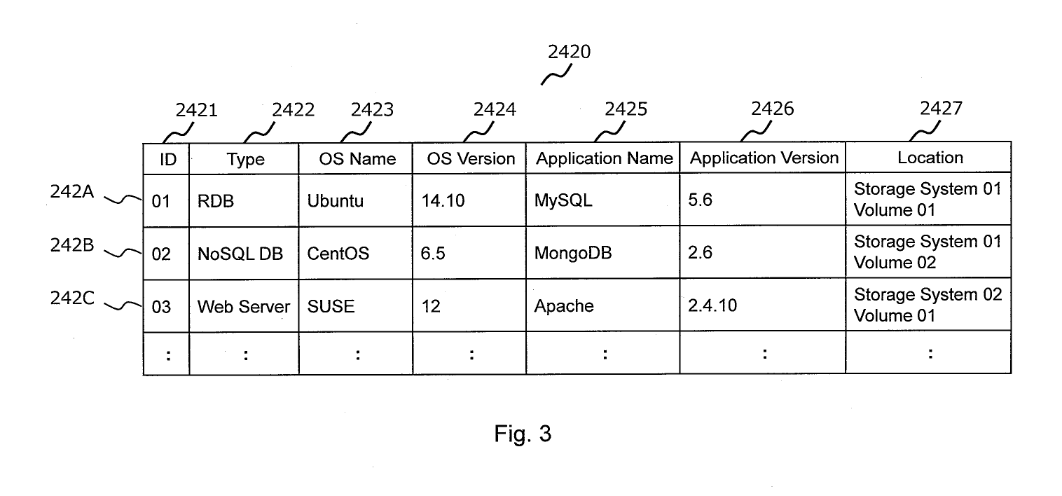

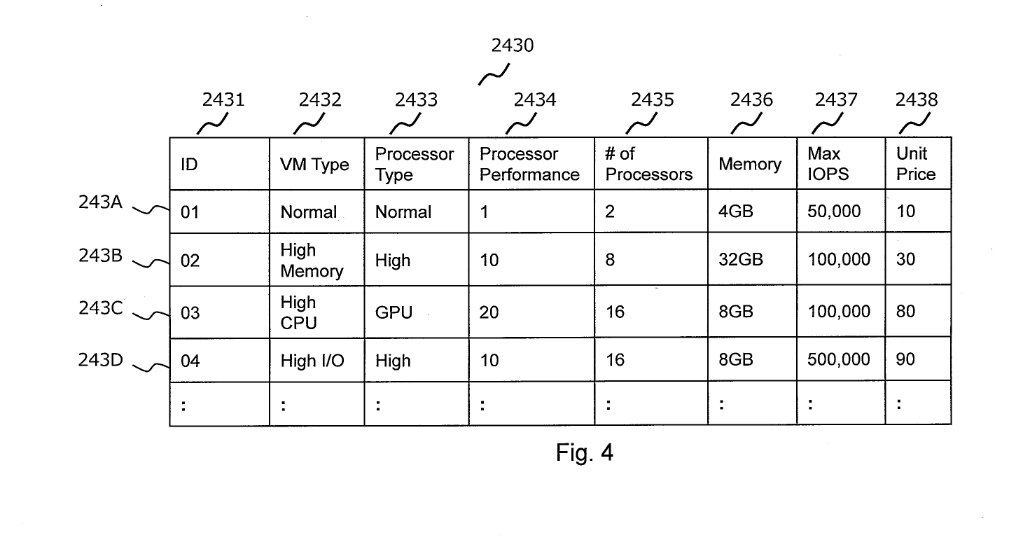

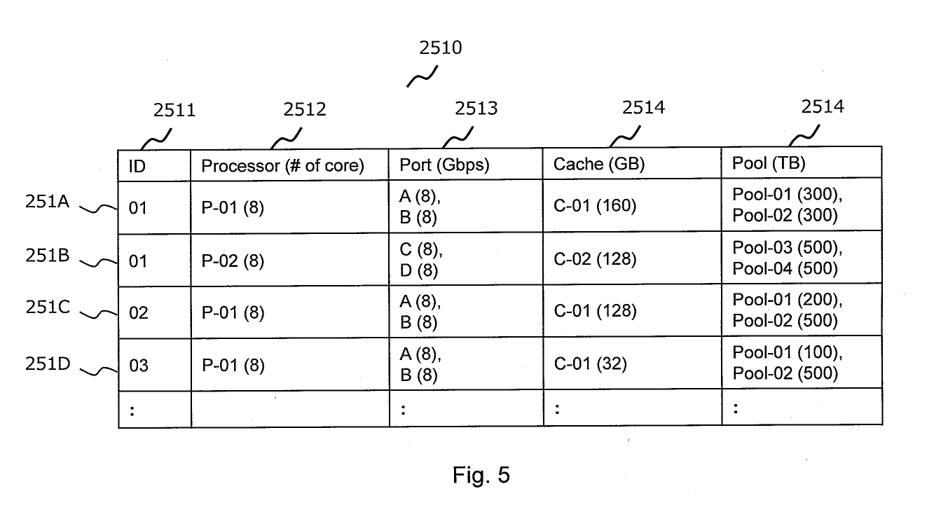

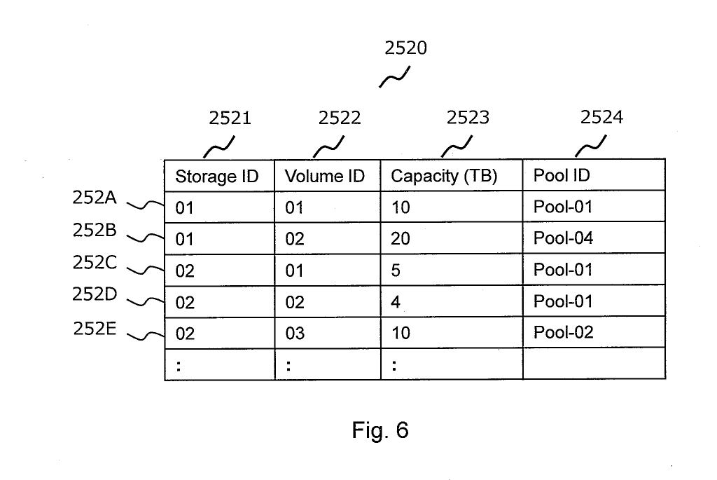

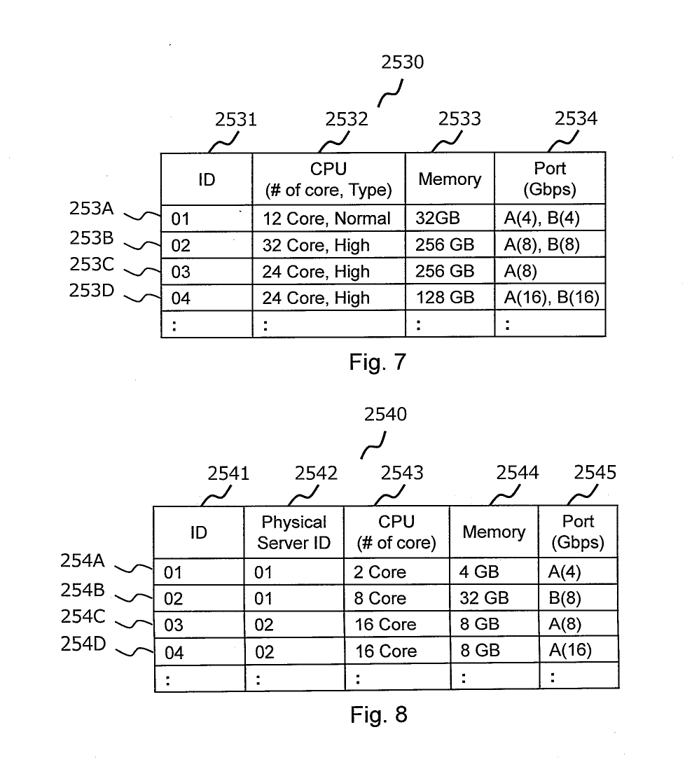

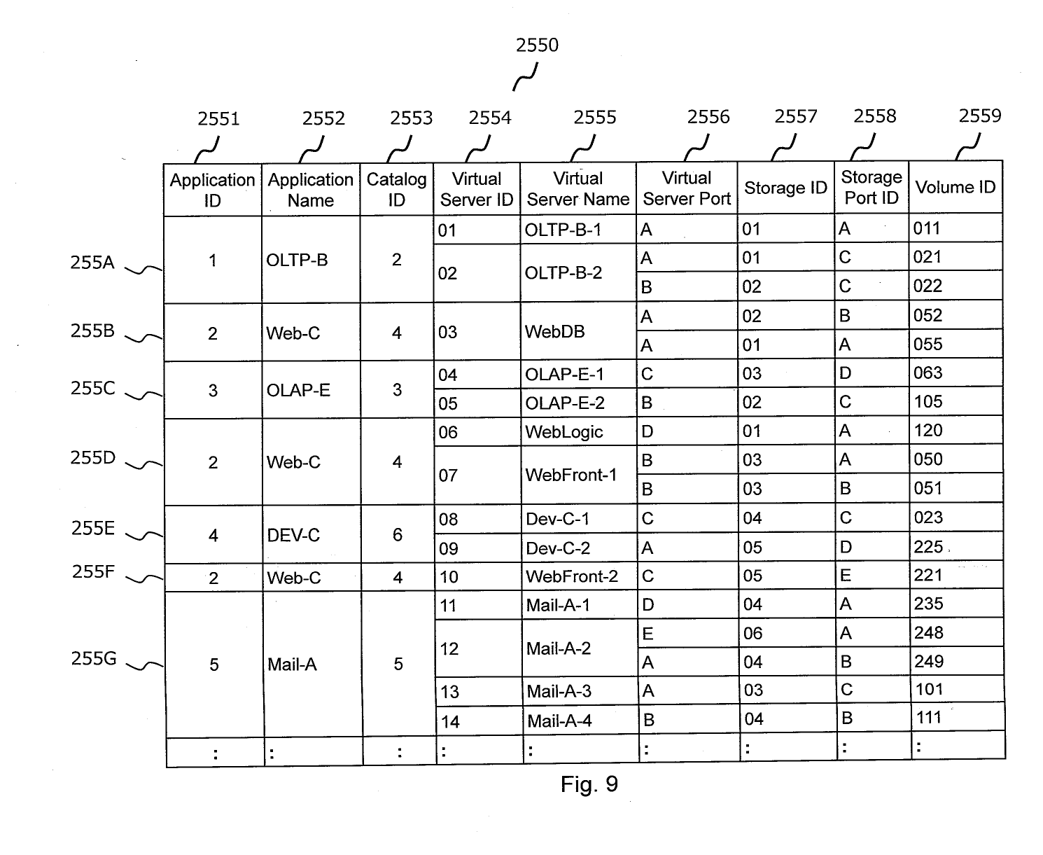

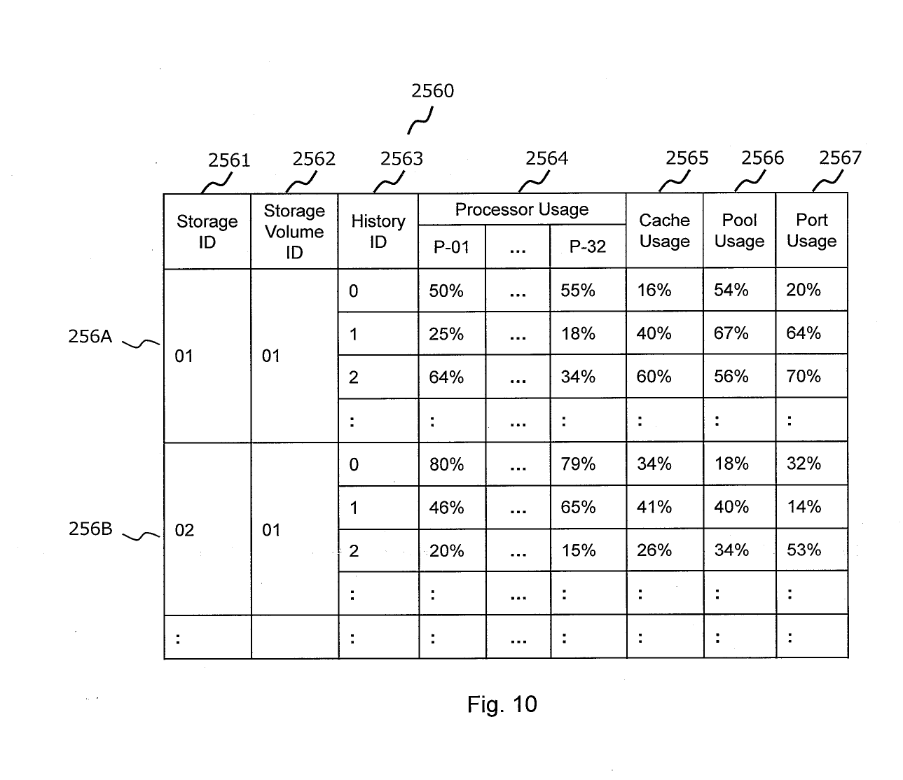

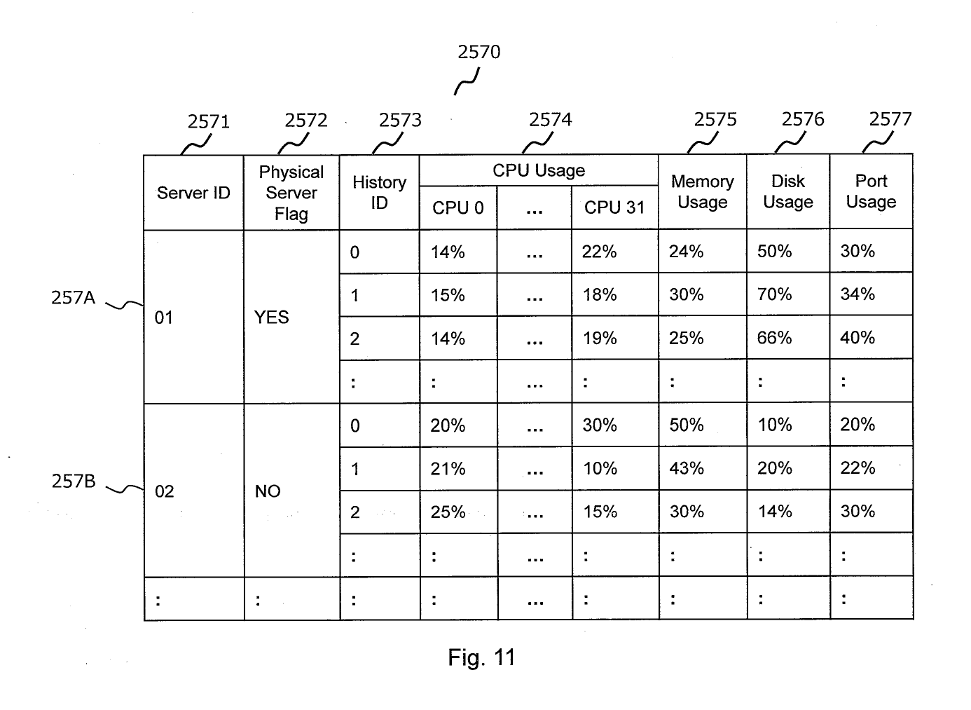

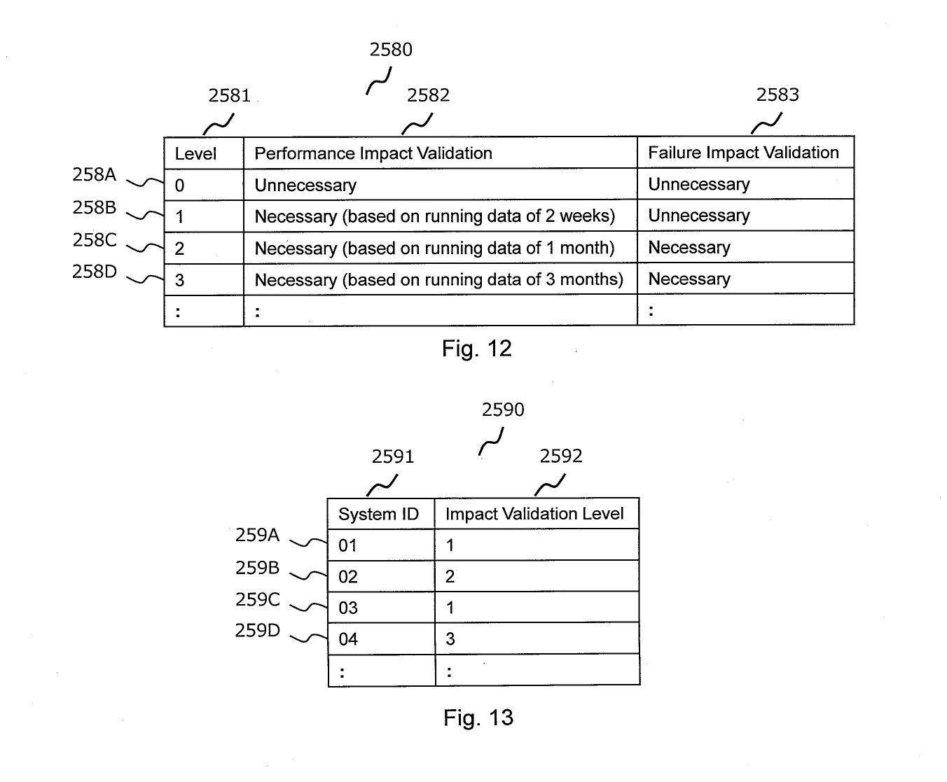

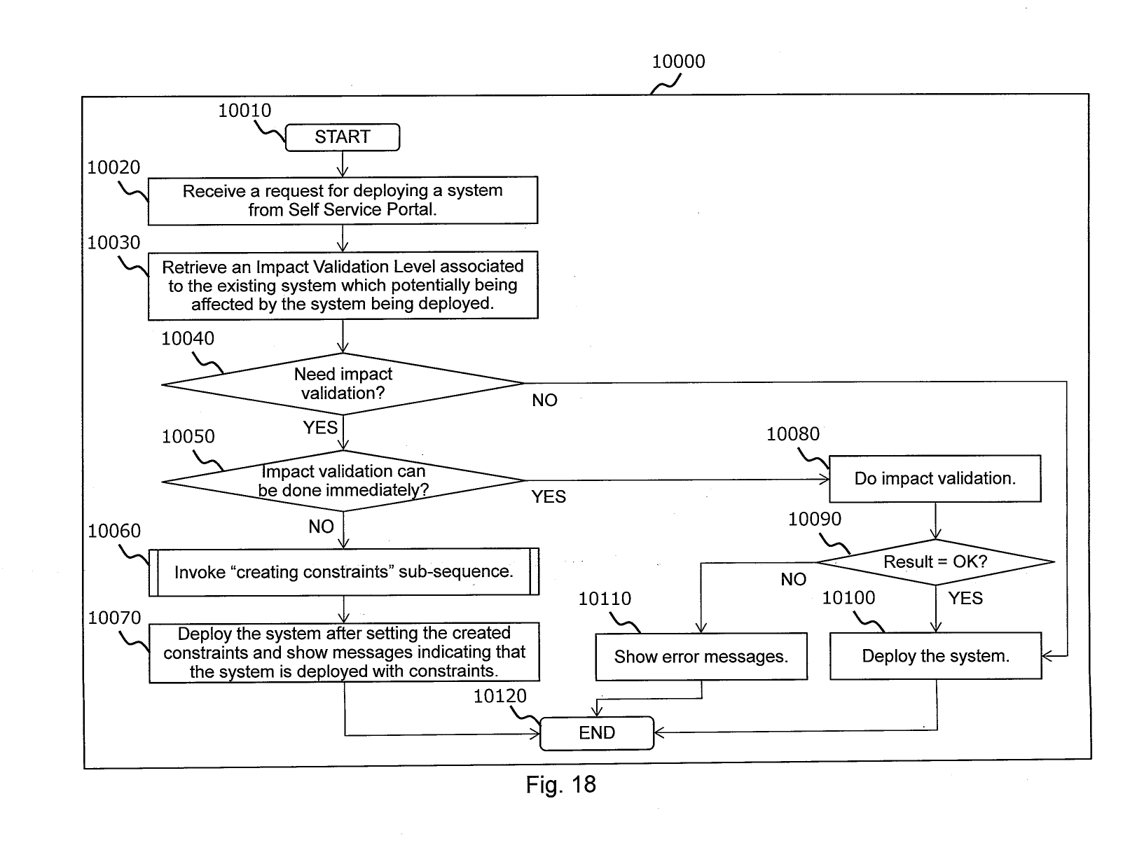

FIG. 2 shows a configuration of the management server of FIG. 1-B. Management interface 2100 is an interface to the management network 5000. Input and output device 2300 is a user interface such as a monitor, a keyboard, and a mouse. Local Disk 2400 contains management program 2410, image catalog table 2420 (FIG. 3), and VM template table 2430 (FIG. 4). Management program 2410 is loaded to Memory 2500 and executed by processor 2200. Procedure of the management program 2410 is described herein below (FIG. 18). Management program 2410 is the same entity as management program 1200 in FIG. 1. Image catalog table 2420 and VM template table 2430 are loaded to Memory 2500 and used by the management program 2410. Memory 2500 contains storage array table 2510 (FIG. 5), storage volume table 2520 (FIG. 6), physical server table 2530 (FIG. 7), virtual server table 2540 (FIG. 8), mapping table 2550 (FIG. 9), storage performance table 2560 (FIG. 10), server performance table 2570 (FIG. 11), impact validation level table 2580 (FIG. 12), and impact validation level association table 2590 (FIG. 13).

FIG. 3 shows an example of the image catalog table 2420. This catalog is referred to when the application administrator 1010 deploys applications by using a self-service portal 1600. This table is loaded from local disk 2400 to memory 2500 of the management server 2000. Column 2421 shows identifications of the catalogs. Column 2422 shows types of the applications. Column 2423 shows names of operating systems on which applications run. Column 2424 shows versions of operating systems on which applications run. Column 2425 shows names of applications. Column 2426 shows versions of applications. Column 2427 shows locations of storage volumes in which the applications are contained. These storage volumes are called “golden images.” Each row (242) shows an image catalog. For example, row 242A shows the catalog of a database application. This catalog includes the MySQL 5.6 on Ubuntu 14.10. This image is located on volume 01 of storage system 01.

FIG. 4 shows an example of the VM template table 2430. This template describes the resource configurations of several VM types. This table is loaded from local disk 2400 to memory 2500 of the management server 2000. Column 2431 shows identifications of the templates. Column 2432 shows VM types. Column 2433 shows processor types. The values of the column can be normal, high memory, high CPU, and High I/O. Column 2434 shows processor performance. The values are relative values on the basis of normal CPU. Column 2435 shows numbers of processors. Column 2436 shows capacities of the memories. Column 2437 shows maximum IOPS (Input/Output Operations Per Second). Column 2438 shows unit prices. Each row (243) shows the resource configuration of a VM type. For example, row 243A shows the configuration of the normal VM. This type of VM has two normal processors and 4 GB memory. Unit price of this type of VM is 10.

FIG. 5 shows an example of the storage array table 2510. This table is created in the memory 2500 by management program 2410. Column 2511 shows identifications of storage arrays. Column 2512 shows processors of the storage arrays. Column 2513 shows ports of the storage arrays. Column 2513 shows cache resources of the storage arrays. Column 2514 shows pools of resources (typically capacities) of the storage arrays. Each row (251) shows the configuration of a physical storage array. For example, rows 251A and 251B show configurations of storage array 01. The storage array has two processors with 8 cores each, 8 Gbps of port A, B, C and D, 160 GB of cache C-01 and 128 GB of cache C-02, 300 TB of pool Pool-01 and Pool-02, and 500 TB of pool Pool-03 and Pool-04.

FIG. 6 shows an example of the storage volume table 2520. This table is created in the memory 2500 by management program 2410. Column 2521 shows identifications of storage arrays owning storage volumes. Column 2522 shows identifications of storage volumes. Column 2523 shows capacities of each storage volume. Column 2524 shows identifications of pools from which storage volumes are curved. Each row (252) shows the configuration of a storage volume. For example, row 252A shows a configuration of storage volume 01 of storage array 01. This storage volume has 10 TB of capacity and curved from Pool-01.

FIG. 7 shows an example of the physical server table 2530. This table is created in the memory 2500 by management program 2410. Column 2531 shows identifications of physical servers. Column 2532 shows numbers of cores and types of CPU of each physical server. Column 2533 shows capacities of memory resources of each physical server. Column 2534 shows ports of each physical server. Each row (253) shows the configuration of a physical server. For example, row 253A shows a configuration of physical server 01. The physical server has 12 cores of Normal CPU, 32 GB of memory, and 4 Gbps of port A and B.

FIG. 8 shows an example of the virtual server table 2540. This table is created in the memory 2500 by management program 2410. Column 2541 shows identifications of the virtual servers. Column 2542 shows identifications of the physical servers on which the virtual servers are running. Column 2543 shows numbers of CPU cores assigned to each virtual server. Column 2544 shows capacities of memory resources assigned to each virtual server. Column 2545 shows ports assigned to each virtual server. Each row (254) shows the configuration of a virtual server. For example, row 254A shows a configuration of virtual server 01. This virtual server is hosted on physical server 01 and has 2 CPU cores, 4 GB of memory, and 4 Gbps of port A.

FIG. 9 shows an example of the mapping table 2550. This table is created in the memory 2500 by management program 2410. Column 2551 shows identifications of applications. Column 2552 shows names of the applications. This name is specified in Application name field 1620-B of GUI 1600-B of self-service portal 1600 by application administrator 1010. Column 2553 shows identifications of image catalogs. Application type is selected in Application type field 1610-B of GUI 1600-B of self-service portal 1600 by application administrator 1010. By matching this information and type column 2422 in the image catalog table 2420, this identification is decided. Column 2554 shows identifications of virtual servers on which the applications are running. Column 2555 shows names of the virtual servers. In this embodiment, these names are automatically created based on application name by management program, but the invention is not limited to this. For example, application administrator can specify the name of each virtual server. Column 2556 shows identifications of ports of the virtual servers. Column 2557 shows identifications of storage arrays. Column 2558 shows identifications of ports of the storage arrays. Column 2559 shows identifications of storage volumes.

Each row (255) shows the end-to-end mapping between applications and storage volumes. For example, row 255B shows that application 2 has name of “Web-C,” is created from image catalog 4, and is running on virtual server 03 whose name is “WebDB.” Also, two storage volumes 052 and 055 are assigned to the virtual server 03 for the application. The storage volume 052 of storage array 02 is assigned to the virtual server 03 through port B of the storage array and port A of the virtual server. The storage volume 055 of storage array 01 is assigned to the virtual server 03 through port A of the storage array and port A of the virtual server.

FIG. 10 shows an example of the storage performance table 2560. This table is created in the memory 2500 by management program 2410. Column 2561 shows identifications of storage arrays. Column 2562 shows identifications of storage volumes. Column 2563 shows identifications of historical performance data of the storage volumes. Timestamps can be used as the history ID 2563. Column 2564 shows usage rates of processors. Column 2565 shows usage rate of cache resources assigned to the storage volumes. Column 2565 shows usage rate of pools from which the storage volumes are curved. Column 2566 shows usage rate of ports assigned to the storage volumes. Each row (256) shows historical performance data of a storage volume. For example, row 256A shows performance data of storage volume 01 of storage array 01 which has at least three historical data (from 0 to 2).

FIG. 11 shows an example of the server performance table 2570. This table is created in the memory 2500 by management program 2410. Column 2571 shows identifications of physical and/or virtual servers. Column 2572 shows flags indicating whether the servers are physical server or not. If the value is “YES,” then the server is a physical server. If the value is “NO” then the server is a virtual server. Column 2573 shows identifications of historical performance data of the servers. Timestamps can be used as the history ID 2573. Column 2574 shows usage rates of CPUs of the servers. Column 2575 shows usage rate of memory resources of the servers. Column 2576 shows usage rate of disks of the servers. Column 2577 shows usage rate of ports of the servers. Each row (257) shows the historical performance data of a server. For example, row 257A shows performance data of server 01 which is a physical server and has at least three historical data (from 0 to 2).

FIG. 12 shows an example of the impact validation level table 2580.

This table is created in the memory 2500 by management program 2410. Column 2581 shows identifications of impact validation levels. Column 2582 shows necessity of performance impact validation. Column 2583 shows necessity of failure impact validation. Each row (258) shows an impact validation level. For example, row 258A shows impact validation level 0 which requires no performance impact validation and no failure impact validation. Row 258B shows impact validation level 1 which requires performance impact validation based on running data of 2 weeks but does not require failure impact validation.

FIG. 13 shows an example of the impact validation level association table 2590. This table is created in the memory 2500 by management program 2410 with respect to a specific system being deployed. Column 2591 shows identifications of systems. Column 2592 shows identifications of impact validation levels. Each row (259) shows association between a system and an impact validation level. For example, row 259A shows that impact validation level 1 is associated to system 01.

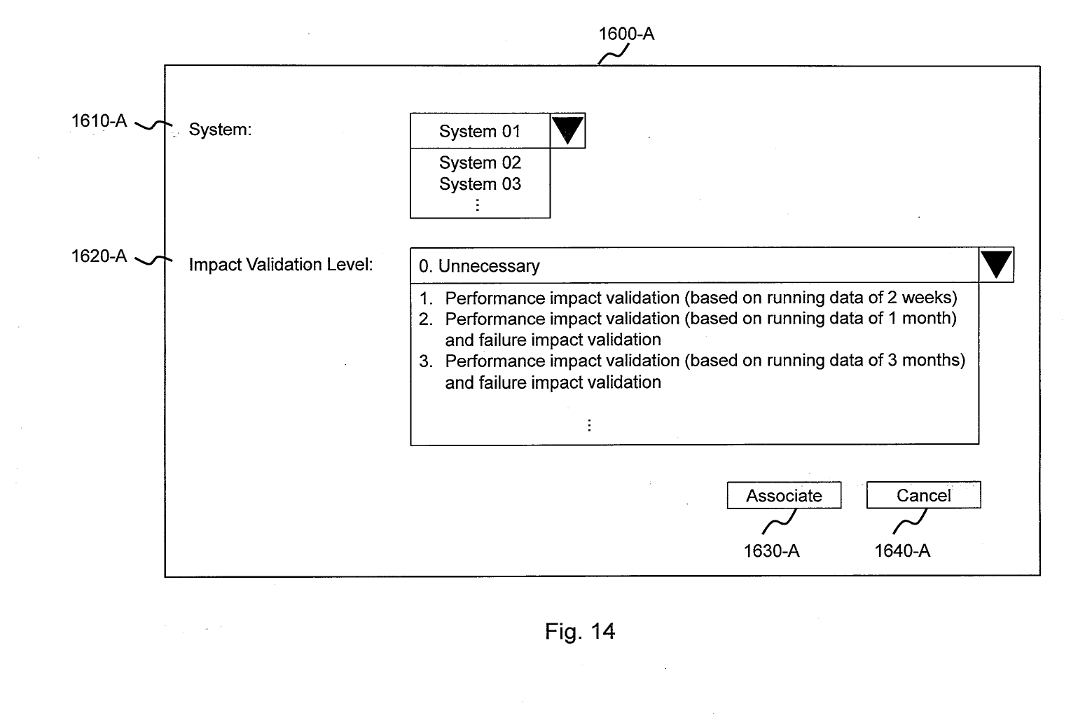

FIG. 14 shows an example of a GUI 1600-A of the self-service portal 1600. This GUI is used when the system administrator 1010 associates an impact validation level to a system. The system administrator selects system 1610-A. Next, the system administrator selects impact validation level 1620-A. If Associate button 1630-A is clicked, the management program 2410 associates the selected impact validation level to the selected system. This association is stored in the impact validation level association table 2590. If Cancel button 1640-A is clicked, the management program 2410 cancels the association process.

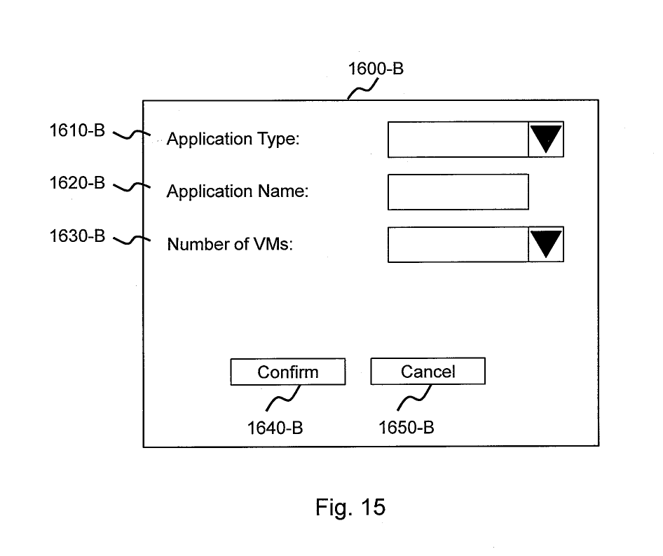

FIG. 15 shows an example of a GUI 1600-B of the self-service portal 1600. This GUI is used when the system administrator 1010 deploys applications on the IT environment 1000. The system administrator selects application type 1610-B such as, for example, “Web Server.” Candidates are displayed based on the type 2422, OS name 2423, OS version 2424, application name 2425, and application version 2426 of the image catalog table 2420. Next, the system administrator inputs an application name 1620-B such as, for example, “Web-A.” Next, the system administrator selects the number of the VMs 1630-B. If Confirm button 1640-B is clicked, the management program 2410 displays confirmation GUI 1600-B. If Cancel button 1650-B is clicked, the management program 2410 cancels the deployment process.

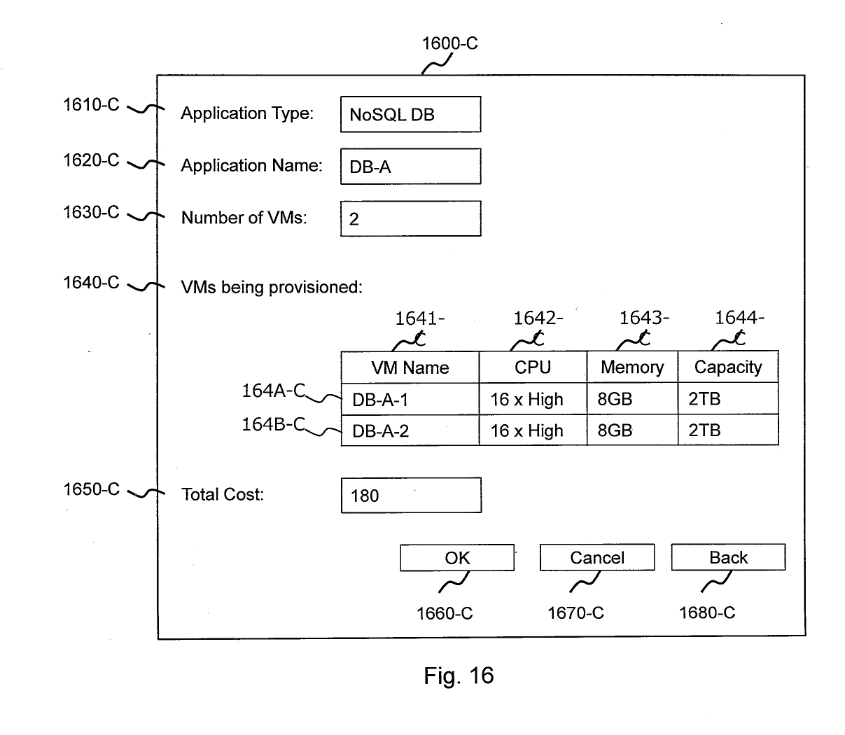

FIG. 16 shows an example of a confirmation GUI 1600-C of the self-service portal 1600. This GUI is displayed after the system administrator 1010 clicked Confirm button 1640-B of the application deployment GUI 1600-B of the self-service portal 1600. Field 1610-C is the application type. Field 1620-C is the application name. Field 1630-C is the number of VMs which run the application. Field 1640-C is the information of the VMs being provisioned. Column 1641-C is the name of the VM. This name is created from application name 1620-C by the management program 2410. Column 1642-C is the number and type of the CPU. Column 1643-C is the capacity of the memory. Column 1644-C is the capacity of storage volumes. Each row (164A-C, 164B-C) shows the configuration of a VM. For example, row 164A-C shows configurations of a VM named “DB-A-1.” This VM has 16 of High CPU, 8 GB memory, and 2 TB of storage volume.

Field 1650-C is calculated total cost of the application. According to a unit price 2438 of VM template table 2430, Unit cost of one “High I/O” VM is 90. The number of “High I/O” VM allocated for this application is 2. Therefore, the total cost of this application is 180. The total cost can include costs of storage volumes. If Confirm button 1660-C is clicked, management program 2410 executes the application deployment process. If Cancel button 1670-C is clicked, management program 2410 cancels the deployment process. If Back button 1680-C is clicked, management program 2410 redisplays the provisioning GUI 1600-B of the self-service portal 1600.

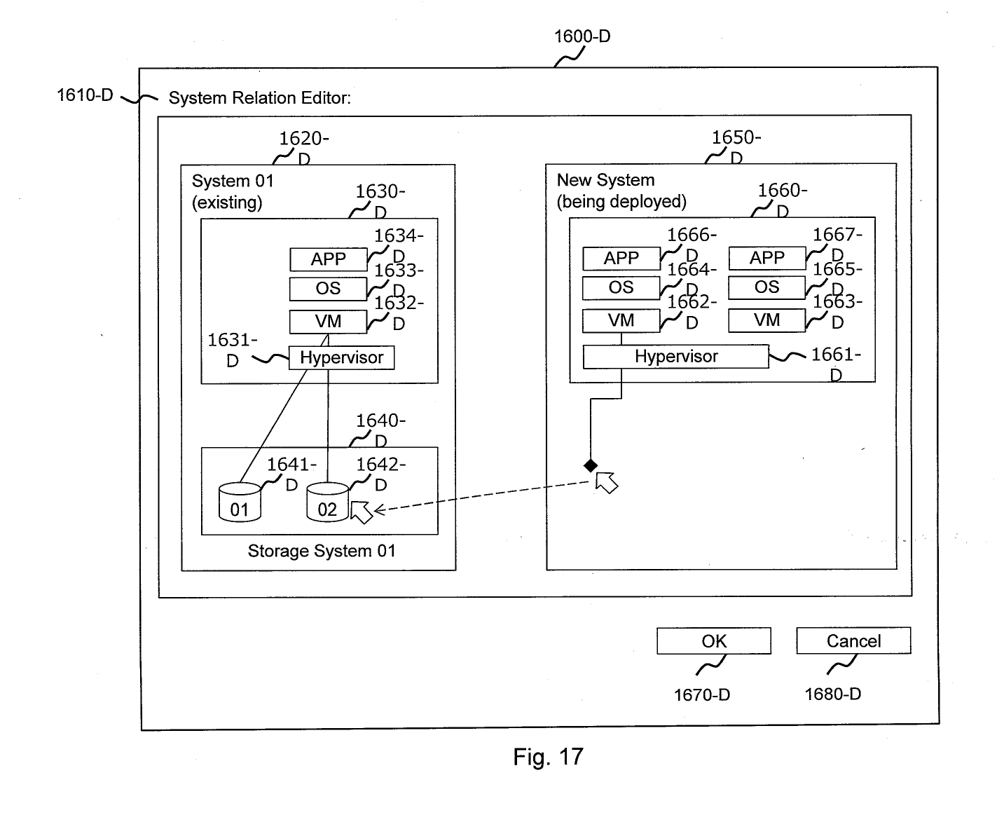

FIG. 17 shows an example of a system relation input GUI 1600-D of the self-service portal 1600. This GUI is used when the system administrator 1010 inputs relationship between a system being deployed and existing systems. The system administrator connects components of the system being deployed and components of the existing systems by using system relation editor 1610-D. VM 1662-D is being connected to storage volume 02 (1642-D) by the system administrator 1010 in this figure. It means that the VM 1662-D accesses to the storage volume 02 (1642-D). If OK button 1670-D is clicked, the management program 2410 saves the relationship. If Cancel button 1680-D is clicked, the management program 2410 cancels the process.

FIG. 18 shows an example of a flow diagram illustrating a process of the management program 2410 for deploying systems. The procedure starts at step 10010. In step 10020, the management program 2410 receives a request for deploying a system from the self-service portal 1600. Parameters shown in FIG. 16 (Self Service Portal—Confirmation GUI) are passed to the management program 2410. In step 10030, the management program 2410 identifies existing systems potentially being affected by the system being deployed according to system relationship input from GUI 1600-D. The management program 2410 retrieves an Impact Validation Level associated to the existing system which is potentially being affected by deployment of the system. In step 10040, the management program 2410 judges whether impact validation is necessary or not. If the result is “Yes” then the process proceeds to step 10050. If the result is “No” then the process proceeds to step 10100.

In step 10050, the management program 2410 judges whether impact validation can be done immediately or not. Assuming that impact validation level 1 is associated to an existing system, if the management program 2410 has performance data of a system being deployed for more than 2 weeks, then it determines that impact validation can be done immediately, for instance. The management program 2410 may use performance data measured in testing environments for this purpose. If the result is “Yes” then the process proceeds to step 10080. If the result is “No” then the process proceeds to step 10060.

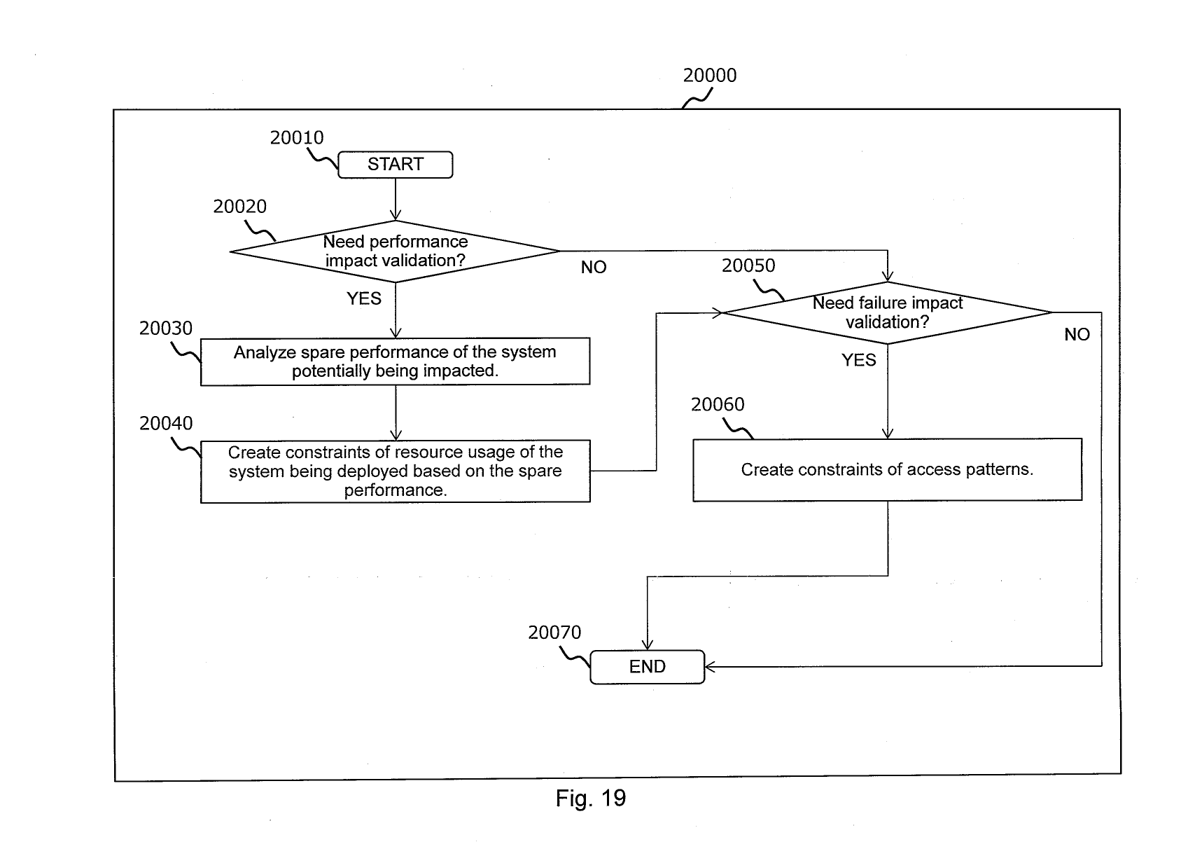

In step 10060, the management program 2410 invokes a sub-sequence of creating constraints. The procedure of this sub-sequence is described herein below (FIG. 19). Constraints not to prevent stable operation of existing system are created by executing this sub-sequence. In step 10070, the management program 2410 deploys the system after setting the created constraints and shows message indicating that the system is deployed with constraints. In step 10080, the management program 2410 executes impact validation. In step 10090, the management program 2410 judges whether the result of impact validation is “OK” or not. If the result is “Yes” then the process proceeds to step 10100. If the result is “No” then the process proceeds to step 10110. In step 10100, the management program 2410 deploys the system after configuring the necessary IT resources. In step 10110, the management program 2410 shows error message indicating that the system cannot be deployed because the result of impact validation is not “OK.” In step 10120, the management program 2410 quits the application deployment process.

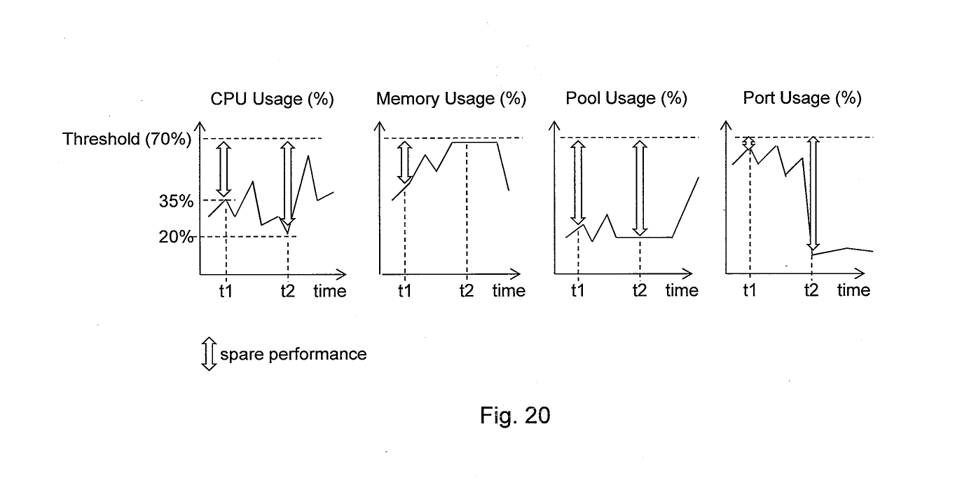

FIG. 19 shows an example of a flow diagram illustrating a process of the management program 2410 for creating constraints sub-sequence. The procedure starts at step 20010. In step 20020, the management program 2410 judges whether performance impact validation is necessary or not based on impact validation level associated to existing systems potentially being affected. If the result is “Yes” then the process proceeds to step 20030. If the result is “No” then the process proceeds to step 20050. In step 20030, the management program 2410 analyzes spare performance of the system potentially being impacted. An example of spare performance is shown in FIG. 20. In step 20040, the management program 2410 creates constraints of resource usage of the system being deployed based on the spare performance. Examples of such constraints include capping I/O from the system being deployed to the existing system, limitation of network bandwidth, setting low priority to network packets transfer between the two systems, and limitation of CPU or memory usage of the system being deployed.

In step 20050, the management program 2410 judges whether failure impact validation is necessary or not based on the impact validation level associated to the existing system potentially being affected. If the result is “Yes” then the process proceeds to step 20060. If the result is “No” then the process proceeds to step 20070. In step 20060, the management program 2410 creates constraints of access pattern from the system being deployed to the existing system. Examples of such constraints include limiting I/O access read-only, allocating different I/O paths between the system being deployed and the existing system from the ones used by the existing system, and limiting candidates of physical servers on which the new system is being deployed. In step 20070, the management program 2410 quits the sub-sequence.

FIG. 20 shows an example of space performance of an existing system potentially being affected. FIG. 20 shows CPU usage, memory usage, pool usage, and port usage of a storage system in an existing system. The CPU usage of the storage system was 35% at t1 and 20% at t2, for example. Assuming that a threshold of 70% is set to CPU usage, spare performance is calculated by subtracting actual CPU usage from threshold. Spare performance is 35% at t1 and 50% at t2. Spare performance of other metrics (memory usage, pool usage and port usage) can be calculated in the same way.

In this embodiment, when the management program deploys new systems, it judges whether impact validation to existing systems can be done immediately. If impact validation is necessary but cannot be done immediately, it creates constraints and deploys new systems after setting the created constraints. By doing this, new systems can be deployed agilely without preventing stable operation of existing IT system.

### Second Embodiment

The second embodiment discloses how the management program eases constraints set to newly deployed systems or re-applies constraints to the systems.

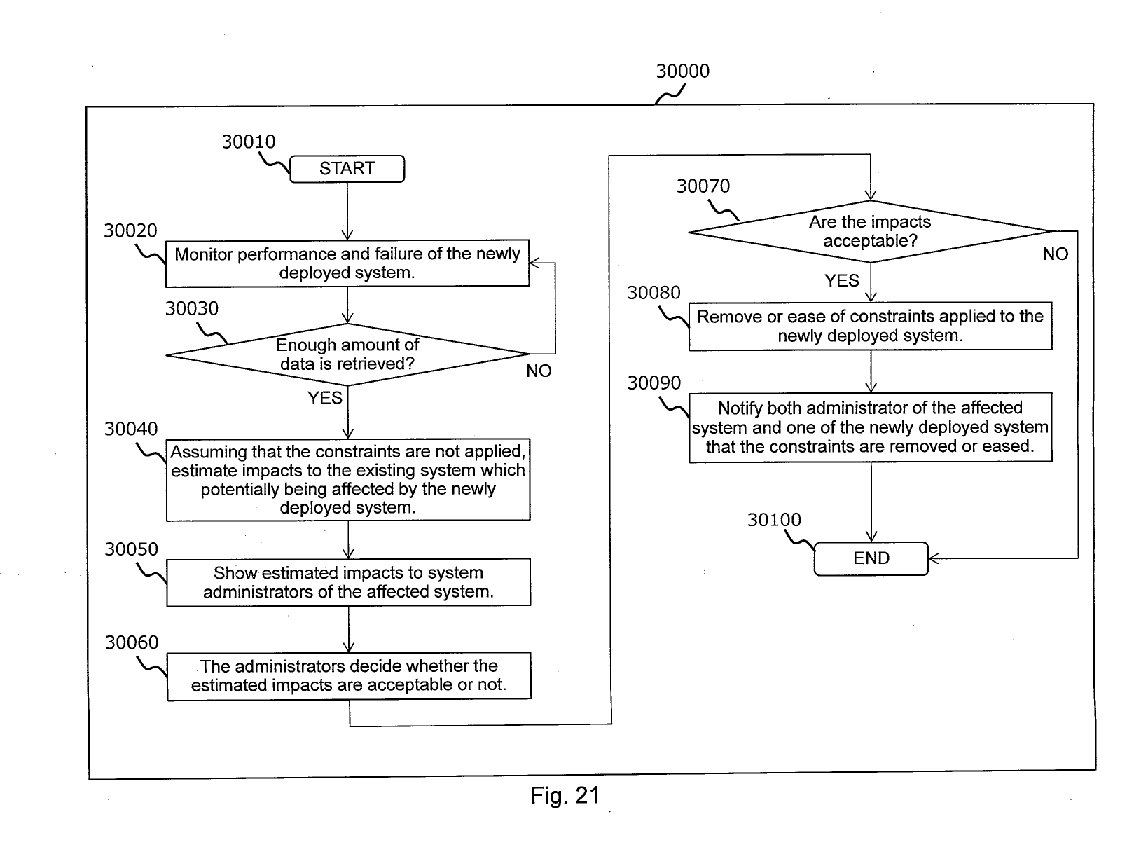

FIG. 21 shows an example of a flow diagram illustrating a process of the management program 2410 for easing of constraints sequence. The procedure starts at step 30010. In step 30020, the management program 2410 monitors performance and failure of the newly deployed system. In step 30030, the management program 2410 judges whether enough amount of data is retrieved or not. Assuming that a system was deployed with constraints in step 10070 in FIG. 18 because there were performance data of less than 2 weeks, if performance data of 2 weeks are gathered then it is judged as enough. If the result is “Yes” then the process proceeds to step 30040. If the result is “No” then the process proceeds to step 30020.

In step 30040, the management program 2410 estimates impacts to the existing system which is potentially being affected by the newly deployed system with the assumption that the constraints are not applied. In step 30050, the management program 2410 shows estimated impacts to the system administrator of the affected system. In step 30060, the system administrator decides whether the estimated impacts are acceptable or not. In step 30070, if the estimated impacts are acceptable then the process proceeds to step 30080. Otherwise the process proceeds to step 30100. In step 30080, the management program 2410 removes or eases the constraints applied to the newly deployed system. In step 30090, the management program 2410 notifies the administrator of the affected system and the administrator of the newly deployed system that the constraints are removed or eased. In step 30100, the management program 2410 quits the sequence.

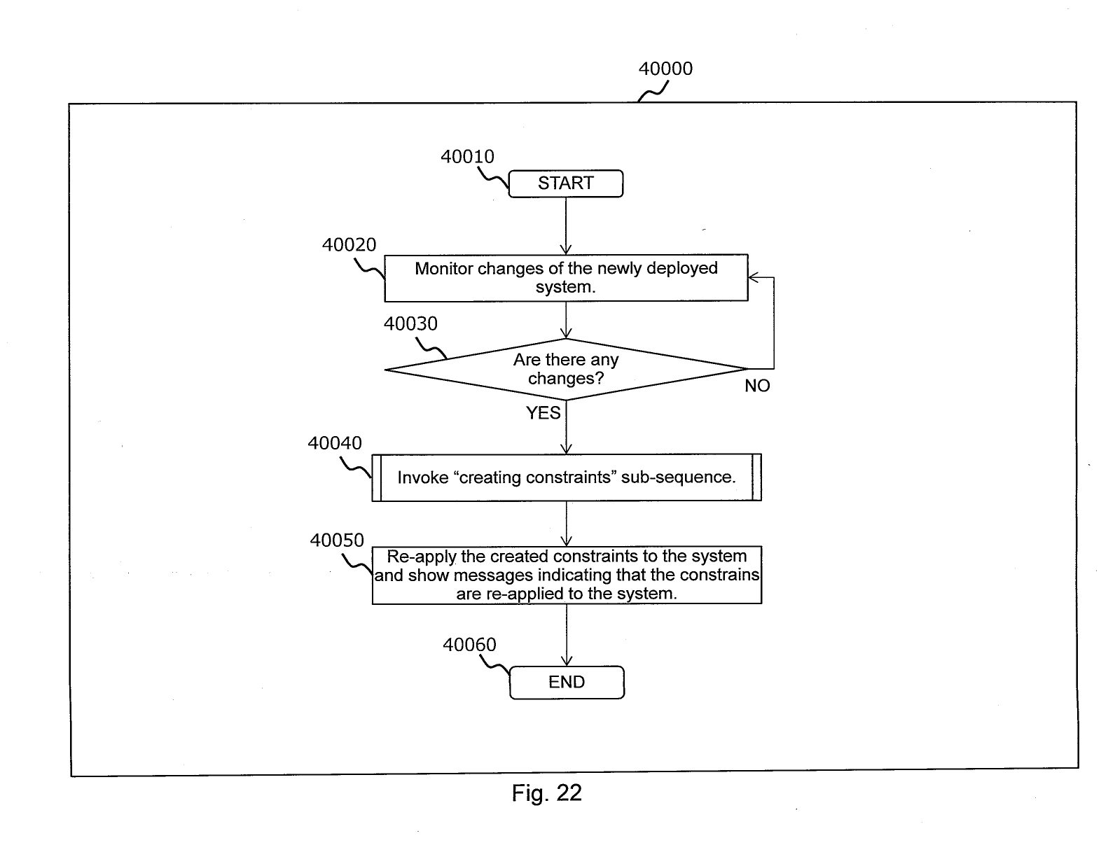

FIG. 22 shows an example of a flow diagram illustrating a process of the management program 2410 for re-applying constraints to the newly deployed systems. The procedure starts at step 40010. In step 40020, the management program 2410 monitors changes of the newly deployed systems. In step 40030, the management program 2410 judges whether there are any changes on them or not. If the result is “Yes” then the process proceeds to the step 40040. If the result is “No” then the process proceeds to the step 40020. In step 40040, the management program 2410 invokes a sub-sequence of creating constraints shown in FIG. 19. In step 40050, the management program 2410 re-applies the created constraints to the system and shows message indicating that the constraints are re-applied to the system. In step 40060, the management program 2410 quits the sequence.

In this embodiment, the management program monitors performance and failure of newly deployed systems. If enough amount of data is retrieved, it estimates impacts to existing systems with the assumption that the constraints are not applied. If the estimated impacts are acceptable for the existing systems, it removes or eases the constraints applied to the newly deployed system. The management program also monitors changes on the newly deployed systems. If there are changes on them, it creates constraints again and re-applies them to the newly applied systems. By doing this, unnecessary constrains can be removed or eased after impact validation is done. It becomes able to re-apply constraints when newly deployed systems are changed and there might be other impacts not validated yet.

This invention discloses how to deploy a new IT system agilely without preventing stable operation of existing IT system(s). When management program deploys new systems it judges whether impact validation to existing systems can be done immediately. If impact validation is necessary but cannot be done immediately, it creates constraints and deploys new systems after setting the created constraints.

Of course, the system configurations illustrated in FIGS. 1 to 1-B are purely exemplary of information systems in which the present invention may be implemented, and the invention is not limited to a particular hardware configuration. The computers and storage systems implementing the invention can also have known I/O devices (e.g., CD and DVD drives, floppy disk drives, hard drives, etc.) which can store and read the modules, programs and data structures used to implement the above-described invention. These modules, programs and data structures can be encoded on such computer-readable media. For example, the data structures of the invention can be stored on computer-readable media independently of one or more computer-readable media on which reside the programs used in the invention. The components of the system can be interconnected by any form or medium of digital data communication, e.g., a communication network. Examples of communication networks include local area networks, wide area networks, e.g., the Internet, wireless networks, storage area networks, and the like.

In the description, numerous details are set forth for purposes of explanation in order to provide a thorough understanding of the present invention. However, it will be apparent to one skilled in the art that not all of these specific details are required in order to practice the present invention. It is also noted that the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged.

As is known in the art, the operations described above can be performed by hardware, software, or some combination of software and hardware. Various aspects of embodiments of the invention may be implemented using circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

From the foregoing, it will be apparent that the invention provides methods, apparatuses and programs stored on computer readable media for deploying new systems agilely without preventing stable operation of existing IT systems. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

What is claimed is:

1. A management computer coupled to a first system, the management computer comprising:
a memory; and
a processor, in receipt of a request to deploy a second system which will issue an access to the first system, being configured to:
create a constraint which limits the access to the first system issued by the second system, and
deploy the second system, to which the created constraint is set, to operate the second system with the created constraint.

2. The management computer according to claim 1, wherein the processor is configured to:
retrieve an impact validation level associated to the first system as a result of deploying the second system;
determine whether impact validation is necessary for the first system based on the retrieved impact validation level; and
if the impact validation is determined to be necessary and if the impact validation cannot be performed immediately, then create the constraint and deploy the second system to operate the second system with the created constraint.

3. The management computer according to claim 2, wherein the processor is configured, upon determining that impact validation is necessary, to determine whether performance impact validation is necessary based on the impact validation level and, if yes, then:
analyze spare performance of the first system; and
create the constraint of resource usage of the second system being deployed based on the spare performance of the first system.

4. The management computer according to claim 3,
wherein the constraint of resource usage of the second system includes one or more of capping I/O (Input/Output) from the second system to the first system, limiting network bandwidth, setting a low priority to network packets transfer between the first and second systems, limiting CPU (Central Processing Unit) usage of the second system, or limiting memory usage of the second system.

5. The management computer according to claim 2, wherein the processor is configured, upon determining that impact validation is necessary, to determine whether failure impact validation is necessary based on the impact validation level and, if yes, then:
create the constraint of access pattern from the second system being deployed to the first system.

6. The management computer according to claim 5,
wherein the constraint of access pattern includes one or more of limiting I/O access to read-only from the second system to the first system, allocating different I/O paths between the first system and the second system from I/O paths used by the first system, or limiting candidates of physical servers on which to deploy the second system.

7. The management computer according to claim 2,
wherein the processor is configured to provide a graphical user interface to an administrator to associate impact validation levels to one or more systems including the first system as a result of deploying the second system;
wherein each impact validation level indicates whether performance impact validation is necessary or not and, if necessary, specifies a period of time of running data for the performance impact validation; and
wherein each impact validation level indicates whether failure impact validation is necessary or not.

8. The management computer according to claim 1, wherein the processor is configured to monitor performance and failure of the deployed second system and, upon collecting sufficient data from the monitoring, then:
estimate impact on the first system by deploying the second system assuming that the created constraint is not applied; and
show the estimated impact to an administrator.

9. The management computer according to claim 8, wherein the processor is configured, upon receiving instruction from the administrator that the estimated impact is acceptable, to:
remove or ease the created constraint applied to the deployed second system.

10. The management computer according to claim 9, wherein the processor is configured to monitor change of the deployed second system and, upon detecting change of the deployed second system which has potential impact on the first system, to:
create another constraint which limits the access to the first system issued by the second system; and
apply the created another constraint to the deployed second system to operate the second system with the created another constraint.

11. A method of managing access to a first system which includes a first processor and a first memory, the method comprising, in receipt of a request to deploy a second system which will issue an access to the first system:
creating a constraint which limits the access to the first system issued by the second system, and
deploying the second system, to which the created constraint is set, to operate the second system with the created constraint.

12. The method according to claim 11, further comprising:
retrieving an impact validation level associated to the first system as a result of deploying the second system;
determining whether impact validation is necessary for the first system based on the retrieved impact validation level; and
if the impact validation is determined to be necessary and if the impact validation cannot be performed immediately, then creating the constraint and deploying the second system to operate the second system with the created constraint.

13. The method according to claim 11, further comprising:
monitoring performance and failure of the deployed second system;
upon collecting sufficient data from the monitoring, then estimating impact on the first system by deploying the second system assuming that the created constraint is not applied, and showing the estimated impact to an administrator; and
upon receiving instruction from the administrator that the estimated impact is acceptable, removing or easing the created constraint applied to the deployed second system.

14. The method according to claim 13, further comprising:
monitoring change of the deployed second system; and
upon detecting change of the deployed second system which has potential impact on the first system, then creating another constraint which limits the access to the first system issued by the second system, and applying the created another constraint to the deployed second system to operate the second system with the created another constraint.

15. A non-transitory computer-readable storage medium storing a plurality of instructions for controlling a data processor to manage access to a first system which includes a first processor and a first memory, the plurality of instructions comprising:
instructions that cause the data processor to create a constraint which limits the access to the first system issued by the second system, and
instructions that cause the data processor to deploy the second system, to which the created constraint is set, to operate the second system with the created constraint.
